(19) United States
(12) Patent Application Publication
(10) Pub. No.: US 2026/0189943 A1
(43) Pub. Date: Jul. 2, 2026

(54) SYSTEMS AND METHODS FOR MONITORING TRAFFIC ROUTING OF CELLULAR INTERNET OF THINGS DEVICES IN A NETWORK

(71) Applicant: Verizon Patent and Licensing Inc., Basking Ridge, NJ (US)

(72) Inventors: Ye HUANG, San Ramon, CA (US); Suzann HUA, Beverly Hills, CA (US); Shanthala KURAVANGI-THAMMAIAH, Keller, TX (US); Robert AVANES, Roanoke, TX (US)

(73) Assignee: Verizon Patent and Licensing Inc., Basking Ridge, NJ (US)

(21) Appl. No.: 19/004,863

(22) Filed: Dec. 30, 2024

(51) Int. Cl. H04W 24/08

(52) U.S. Cl. CPC H04W 24/08

(57) ABSTRACT

A device may receive subscription data associated with a cIoT device and that includes a first attribute and a second attribute, and may receive a monitoring events report configuration for the cIoT device. The device may determine whether a UE identified in the monitoring events report configuration matches the first attribute, and may determine whether mobility of the cIoT device matches the second attribute. The device may utilize an interface to an HSS based on determining that the UE identified in the monitoring events report configuration matches the first attribute and that the mobility of the cIoT device matches the second attribute, and may provide a monitoring events configuration command to the HSS via the interface. The device may receive a monitoring events report from the HSS based on providing the monitoring events configuration command to the HSS, and may provide the monitoring events report to an application server.

### BACKGROUND

A cellular Internet of Things (cIoT) device is a type of device that connects to the Internet using a cellular network, and that leverages infrastructure and protocols typically associated with mobile phone communications. Examples of a cIoT device may include a smart meter, an asset tracker, a wearable health monitor, a connected vehicle, an industrial sensor, and/or the like.

### BRIEF DESCRIPTION OF THE DRAWINGS

FIGS. 1A-1E are diagrams of an example associated with monitoring traffic routing of cIoT devices in a network.

FIGS. 2 and 3 are diagrams of example environments in which systems and/or methods described herein may be implemented.

FIG. 4 is a diagram of example components of one or more devices of FIGS. 4 and 5.

FIG. 5 is a flowchart of an example process for monitoring traffic routing of cIoT devices in a network.

### DETAILED DESCRIPTION OF EXAMPLE EMBODIMENTS

The following detailed description of example implementations refers to the accompanying drawings. The same reference numbers in different drawings may identify the same or similar elements.

A cIoT device relies on robust and efficient network connectivity to facilitate various innovative applications, such as smart city infrastructure, industrial automation, and remote monitoring. However, the transition from fourth-generation (4G) networks to fifth-generation (5G) networks presents technical challenges for existing cIoT devices that were designed for compatibility with the 4G architecture. One challenge is the rapid increase in a quantity of cIoT devices connecting to carrier networks (e.g., a category M1 (Cat-M1) network). As carriers plan to eliminate 4G networks, 4G cIoT devices will need to be supported within 5G networks without causing disruption to end users or requiring significant device upgrades. Moreover, existing standards bodies and industry organizations have been slow to adapt, leaving carriers to devise their own solutions for integrating cIoT devices into 5G networks. The current standard for monitoring subscription and reporting schemes of cIoT devices relies on a configuration and reporting system that unnecessarily burdens unified data management (UDM) and home subscriber server (HSS) capacities, leading to inefficient processing and potential network congestion. Thus, current techniques for managing cIoT devices consume computing resources (e.g., processing resources, memory resources, communication resources, and/or the like), networking resources, and/or other resources associated with failing to support 4G cIoT devices in 5G networks, handling end user complaints based on failing to support 4G cIoT devices in 5G networks, generating network congestion based on monitoring subscription and reporting schemes of cIoT devices, and/or the like.

Some implementations described herein provide a device that monitors traffic routing of cIoT devices in a network. For example, a device may receive subscription data associated with a cIoT device and that includes a first attribute and a second attribute, and may receive a monitoring events report configuration for the cIoT device. The device may determine whether a user equipment (UE) identified in the monitoring events report configuration matches the first attribute, and may determine whether mobility of the cIoT device matches the second attribute. The device may utilize an interface to an HSS based on determining that the UE identified in the monitoring events report configuration matches the first attribute and that the mobility of the cIoT device matches the second attribute, and may provide a monitoring events configuration command to the HSS via the interface. The device may receive a monitoring events report from the HSS based on providing the monitoring events configuration command to the HSS, and may provide the monitoring events report to an application server.

In this way, the device monitors traffic routing of cIoT devices in a network. For example, the device may address the technical challenges associated with transitioning cIoT devices to 5G networks by enabling the use of existing 4G cIoT devices within the 5G architecture without significant upgrades. The device may enhance network efficiency by mitigating the load on UDM and HSS components, thereby preventing network congestion and minimizing signaling overhead. The device may facilitate scalable integration of cIoT devices into 5G networks, preserving network performance and stability during the migration process and allowing for flexible updates to the subscription attributes in response to evolving network configurations. Thus, the device may conserve computing resources, networking resources, and/or other resources that would have otherwise been consumed by failing to support 4G cIoT devices in 5G networks, handling end user complaints based on failing to support 4G cIoT devices in 5G networks, generating network congestion based on monitoring subscription and reporting schemes of cIoT devices, and/or the like.

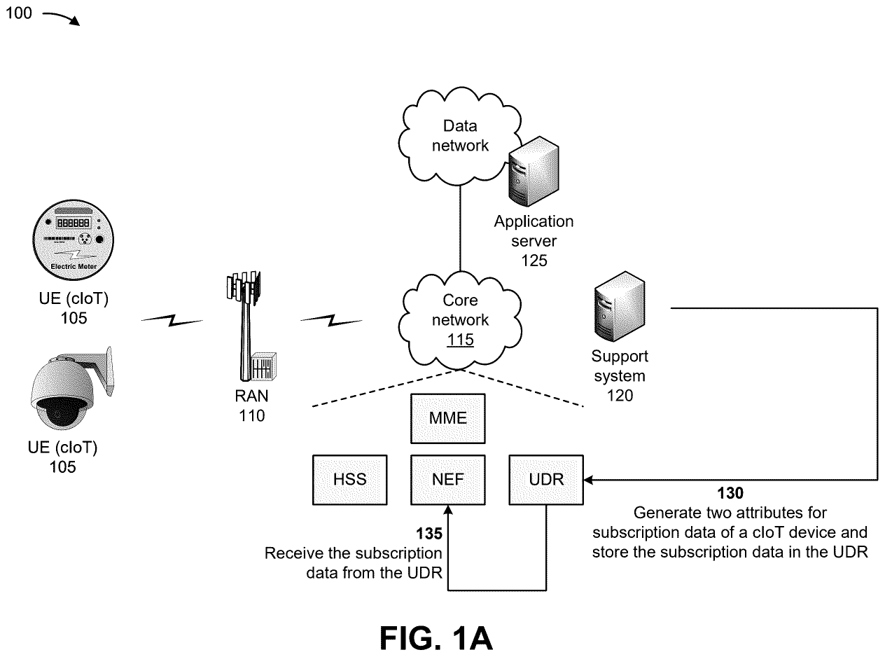

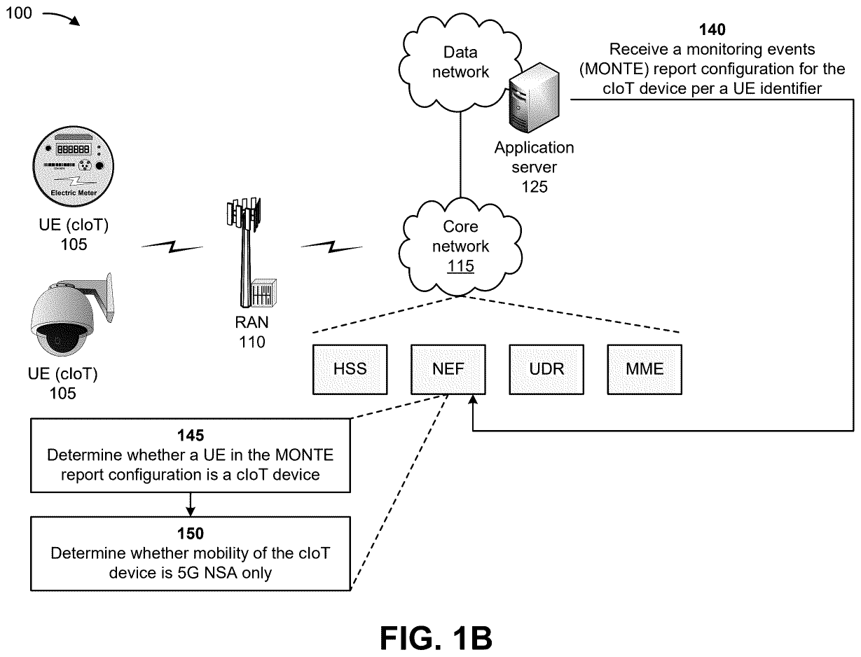

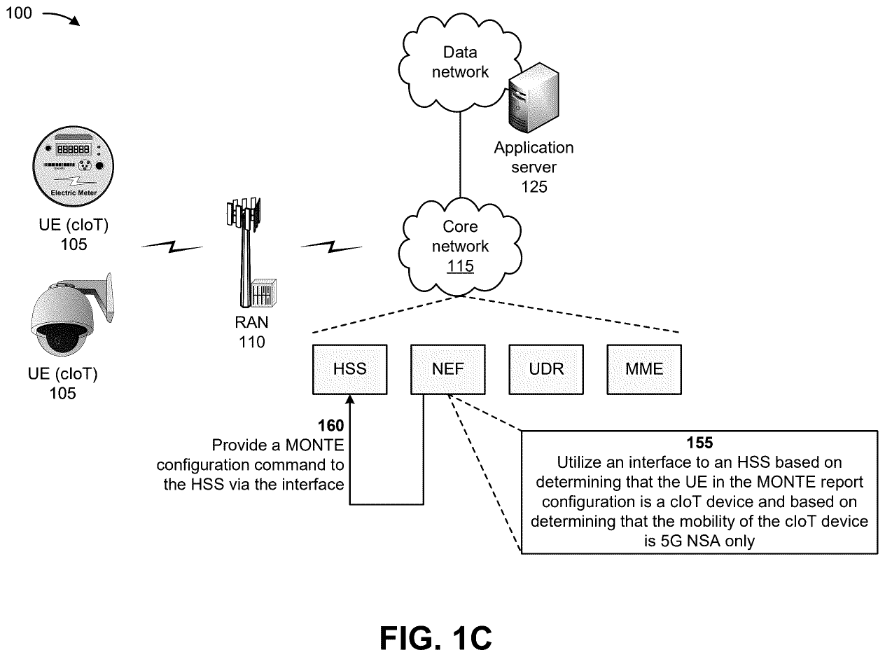

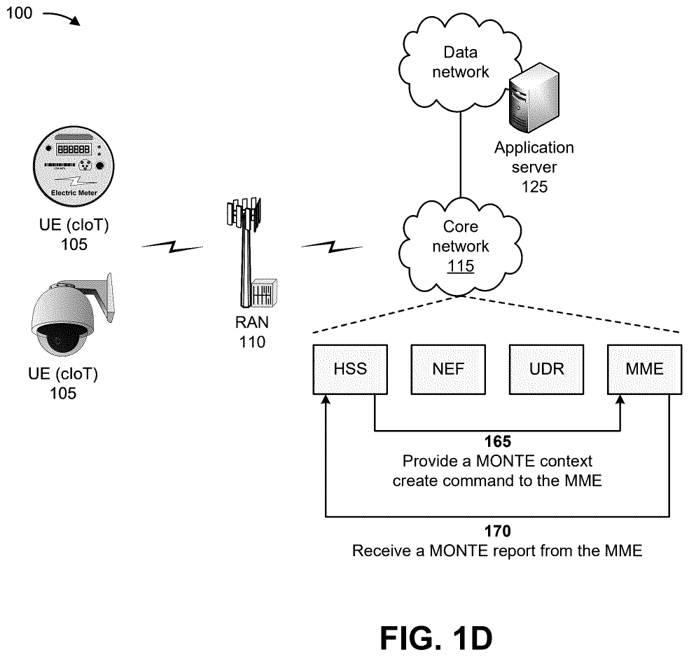

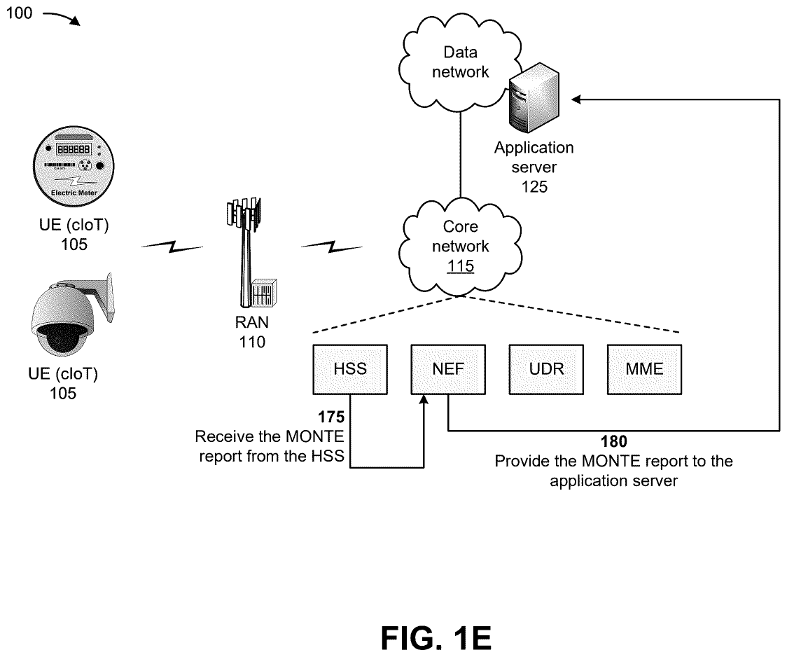

FIGS. 1A-1E are diagrams of an example 100 associated with monitoring traffic routing of cIoT devices in a network. As shown in FIGS. 1A-1E, the example 100 includes user equipments (UEs) (e.g., cIoT devices) 105, a radio access network (RAN) 110, a core network 115, a support system 120, and a data network associated with an application server 125. The core network 115 may include a mobility management entity (MME), an HSS, a network exposure function (NEF), and a unified data repository (UDR). Further details of the UEs 105, the RAN 110, the core network 115, the support system 120, the application server 125, the data network, the MME, the HSS, the NEF, and the UDR are provided elsewhere herein.

As shown in FIG. 1A, the UEs 105 may wirelessly connect with the RAN 110, and the RAN 110 may enable the UEs 105 to communicate with the core network 115 and/or the application server 125. In some implementations, the RAN 110 may enable the UEs 105 to communicate with the data network and/or the application server 125.

As further shown in FIG. 1A, and by reference number 130, the support system 120 may generate two attributes for subscription data of a cIoT device 105 and may store the subscription data in the UDR. For example, a user may utilize the support system 120 to generate subscription data associated with provisioning one or more of the cIoT devices 105. The subscription data may include multiple attributes, such as an attribute that indicates a radio access technology (RAT) type for a cIoT device 105, an attribute that indicates a 5G non-standalone (NSA) configuration for operating a cIoT device 105, an attribute that includes operational parameters of a cIoT device 105 for proper network provisioning, and/or the like. In some implementations, the support system 120 may store the subscription data with the multiple attributes in the UDR. This may ensure that the subscription data is available for quick access by various network components. The UDR may facilitate easier management and scalability of the subscription data attributes.

In some implementations, the subscription data associated with the cIoT device 105 may be stored in a structured format within the UDR. For example, the subscription data may be organized in a JavaScript object notation (JSON) format with fields for the RAT type attribute (e.g., RAT type: “NB-IoT”) and the mobility attribute (e.g., mobility config: “5G NSA”). The UDR may support RESTful application programming interface (API) calls for querying and updating the subscription data. Additionally, or alternatively, the support system 120 may provide the subscription data with the multiple attributes to the NEF. The NEF may store the subscription data with the multiple attributes in the UDR. This may enable the NEF to have control over storing and managing the subscription data attributes.

As further shown in FIG. 1A, and by reference number 135, the NEF may receive the subscription data from the UDR. For example, the NEF may request the subscription data from the UDR, and the UDR may provide the subscription data to the NEF based on the request. Additionally, or alternatively, the UDR may continuously provide the subscription data to the NEF, may periodically provide the subscription data to the NEF, and/or the like. Additionally, or alternatively, the NEF may receive the subscription data directly from the support system 120 instead of the UDR. This direct communication may reduce latency and potential communication bottlenecks. Additionally, or alternatively, the NEF may receive updates to the subscription data from the support system, the application server 125, and/or the UDR. This may enable the NEF to obtain real-time updates necessary for effective monitoring and management of cIoT devices 105.

As shown in FIG. 1B, and by reference number 140, the NEF may receive a monitoring events (MONTE) report configuration for the cIoT device 105 per a UE identifier. For example, the NEF may receive the MONTE report configuration from the application server 125. The MONTE report configuration may specify one or more parameters for monitoring the cIoT device 105 (e.g., as identified by the UE identifier), such as event types to be reported, reporting intervals, and other relevant monitoring criteria. The MONTE report configuration may enable the NEF to manage and monitor the cIoT device 105 effectively. In some implementations, receiving the MONTE report configuration may include utilizing an API with the application server 125 to receive the MONTE report configuration from the application server 125. For example, the application server 125 may utilize the API to generate and send the MONTE report configuration to the NEF.

As further shown in FIG. 1B, and by reference number 145, the NEF may determine whether a UE identified in the MONTE report configuration is a cIoT device 105. For example, the NEF may compare the UE identifier in the MONTE report configuration with the subscription data to determine whether the UE corresponds to a cIoT device 105. This determination may include the NEF checking whether the subscription data includes attributes indicating a cIoT RAT type, such as narrowband-IoT (NB-IoT) or Category M1 (Cat-M1). In some implementations, the NEF may determine that UE identified in the MONTE report configuration is a cIoT device 105. Alternatively, the NEF may determine that UE identified in the MONTE report configuration is not a cIoT device 105. In some implementations, the NEF may be configured to utilize a model for determining whether the UE identified in the MONTE report configuration matches the first attribute (e.g., the RAT type attribute). For example, the NEF may compare the UE's unique identifier with a stored list of identifiers associated with cIoT devices using a hash-based lookup operation.

As further shown in FIG. 1B, and by reference number 150, the NEF may determine whether mobility of the cIoT device 105 is 5G NSA only. For example, when the NEF determines that UE identified in the MONTE report configuration is a cIoT device 105, the NEF may check the subscription data to determine whether the mobility attribute for the cIoT device 105 specifies operation under a 5G NSA configuration. This determination may ensure that the mobility of the cIoT device 105 is restricted to 5G NSA, which may optimize network resource utilization and may ensure compatibility during a transition period from 4G to 5G networks. In some implementations, the NEF may determine that the mobility of the cIoT device 105 is 5G NSA only. Alternatively, the NEF may determine that the mobility of the cIoT device 105 is not 5G NSA only. In some implementations, determining the RAT type and mobility of the cIoT device 105 may include a future-proofing check performed by the NEF. For example, the process of verifying the cIoT RAT type and mobility attribute not only ensures current compatibility but also provides future proofing when 5G standalone (SA) supports NB-IoT and/or Cat-M1 configurations. This check may help in maintaining long-term network compatibility and readiness for future technological advancements.

As shown in FIG. 1C, and by reference number 155, the NEF may utilize an interface to an HSS based on determining that the UE identified in the MONTE report configuration is a cIoT device 105 and based on determining that the mobility of the cIoT device 105 is 5G NSA only. For example, if the NEF determines that the UE identified in the MONTE report configuration is not a cIoT device 105 or determines that the mobility of the cIoT device 105 is not 5G NSA only, the NEF may not utilize the interface to the HSS. Alternatively, if the NEF determines that the UE identified in the MONTE report configuration is a cIoT device 105 and determines that the mobility of the cIoT device 105 is 5G NSA only, the NEF may utilize the interface to the HSS. For example, the NEF may interact with the HSS directly using an interface (e.g., an S6t interface) rather than routing through a UDM component of the core network 115. This direct interaction with the HSS may optimize network resource usage by reducing the load on the UDM component and preventing unnecessary signaling overhead.

In some implementations, after determining that the UE identified in the MONTE report configuration is a cIoT device 105 with mobility restricted to 5G NSA, the NEF may utilize an optimized interface to directly communicate with the HSS. For example, this optimized interface may enhance data transfer efficiency and minimize delays. Additionally, or alternatively, if the NEF determines that the UE identified in the MONTE report configuration is a cIoT device 105 with mobility restricted to 5G NSA, the NEF may bypass the UDM component and interact with the HSS via the S6t interface. This bypass may further streamline communication pathways and reduce processing load on the UDM component.

In some implementations, the interface utilized by the NEF to communicate with the HSS may be implemented using the S6t interface. This interface may support Diameter protocol messages for transferring subscription data and monitoring events configuration commands. The S6t interface configuration may include parameters such as Internet protocol (IP) address, port number, and encryption settings to ensure secure communication. The MONTE report configuration may specify parameters such as event types (e.g., network attach, location update, etc.), reporting intervals (e.g., every five minutes), and thresholds (e.g., signal strength below a value). These configurations may be defined in an XML schema and may be validated using an XML schema definition (XSD) before being sent to the HSS. Operational parameters for the cIoT devices 105, such as the expected data throughput, latency requirements, and power consumption, may also be detailed in the MONTE report configuration.

As further shown in FIG. 1C, and by reference number 160, the NEF may provide a MONTE configuration command to the HSS via the interface. For example, the NEF may generate a MONTE configuration command that configures monitoring events for the cIoT device 105 and specifies parameters, such as event types and reporting intervals. The NEF may utilize the interface to provide the MONTE configuration command directly to the HSS, rather than routing through the UDM component of the core network 115. This may ensure efficient monitoring and management of the cIoT device 105 within the 5G network infrastructure.

As shown in FIG. 1D, and by reference number 165, the HSS may provide a MONTE context create command to the MME. For example, the HSS may create a MONTE context create command based on receiving the MONTE configuration command from the NEF. The HSS may provide the MONTE context create command to the MME. In some implementations, the MONTE context create command may ensure that the HSS establishes necessary context for monitoring events associated with the cIoT device 105 and that the monitoring events are accurately tracked and reported by the MME. As an example, the HSS may collaborate with the MME to set up contexts needed for efficient event monitoring of the cIoT device 105.

As further shown in FIG. 1D, and by reference number 170, the HSS may receive a MONTE report from the MME. For example, the MME may track monitoring events associated with the cIoT device 105 based on receiving the MONTE context create command from the HSS. The MME may generate a MONTE report that includes information associated with tracking the monitoring events of the cIoT device 105. The MME may provide the MONTE report to the HSS, and the HSS may receive the MONTE report from the MME. The MONTE report may include a variety of information associated with monitoring and managing the performance, connectivity, and other operational parameters of the cIoT device 105. For example, the MONTE report may include event types (e.g., network attachments and detaches, location updates and/or changes, etc.), device identifiers (e.g., a UE identifier, an International Mobile Subscriber Identity (IMSI), an International Mobile Equipment Identity (IMEI), etc.), location Information (e.g., a cell identifier, a tracking area code (TAC), etc.), mobility information (e.g., mobility events, current RAT type, etc.), network performance metrics (e.g., signal strength, data throughput, etc.), and/or the like.

As shown in FIG. 1E, and by reference number 175, the NEF may receive the MONTE report from the HSS. For example, the HSS may receive the MONTE report from the MME, and may forward the MONTE report to the NEF. In some implementations, the HSS may route the MONTE report to the NEF based on the cIoT mobility attribute, and the NEF may receive the MONTE report from the HSS. For example, when the HSS determines that the cIoT mobility attribute is set to 5G NSA only, the HSS may provide the MONTE report via the interface (e.g., the S6t interface) to the NEF, ensuring that the MONTE report is accurately delivered and processed. The direct receipt of the MONTE report by the NEF and from the HSS may enable faster and more efficient processing of the MONTE report.

As further shown in FIG. 1E, and by reference number 180, the NEF may provide the MONTE report to the application server 125. For example, after receiving the MONTE report from the HSS, the NEF may forward the MONTE report to the application server 125 for further processing and utilization. Additionally, or alternatively, the NEF may send the MONTE report to the application server 125. In some implementations, the application server 125 may perform one or more actions based on the MONTE report. For example, the MONTE report may provide detailed information about events observed and recorded by the cIoT device 105, such as network attachments, detaches, location updates, signal strength, data throughput, and other performance metrics. By analyzing this data, the application server 125 may monitor the overall performance and health of the cIoT device 105 and interactions with the network. The MONTE report may include information about specific events that the cIoT device 105 encounters, such as mobility events, location changes, and network access events. The application server 125 may utilize this information to track and log events for record-keeping, auditing, or compliance purposes. In some implementations, by receiving real-time updates on the events occurring on the cIoT device 105 (e.g., via the MONTE report), the application server 125 may quickly detect faults, anomalies, or unusual behaviors. Alternatively, or additionally, the application server 125 may utilize the information in the MONTE report to determine how the cIoT device 105 utilizes network resources. Alternatively, or additionally, the application server 125 may utilize the information in the MONTE report to improve the end-user experience by ensuring reliable connectivity and performance of the cIoT device 105. Alternatively, or additionally, the application server 125 may utilize the information in the MONTE report to predict potential failures and maintenance needs for the cIoT device 105. Alternatively, or additionally, the application server 125 may utilize the information in the MONTE report to maintain logs and records necessary for regulatory compliance.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

In this way, the device monitors traffic routing of cIoT devices 105 in a network. For example, the device may address the technical challenges associated with transitioning cIoT devices 105 to 5G networks by enabling the use of existing 4G cIoT devices 105 within the 5G architecture without significant upgrades. The device may enhance network efficiency by mitigating the load on UDM and HSS components, thereby preventing network congestion and minimizing signaling overhead. The device may facilitate scalable integration of cIoT devices 105 into 5G networks, preserving network performance and stability during the migration process and allowing for flexible updates to the subscription attributes in response to evolving network configurations.

To support the transition of new customers to a 5G core network, the implementations described herein ensure that new cIoT devices 105 are seamlessly inducted into the 5G architecture. Simultaneously, the implementations extend the operational lives of existing 4G cIoT devices 105, such as those utilizing Cat-M1 and NB-IoT configurations, even after the planned sunset of the 4G network. Thus, the implementations may conserve computing resources, networking resources, and/or other resources that would have otherwise been consumed by failing to support 4G cIoT devices 105 in 5G networks, handling end user complaints based on failing to support 4G cIoT devices 105 in 5G networks, generating network congestion based on monitoring subscription and reporting schemes of cIoT devices 105, and/or the like.

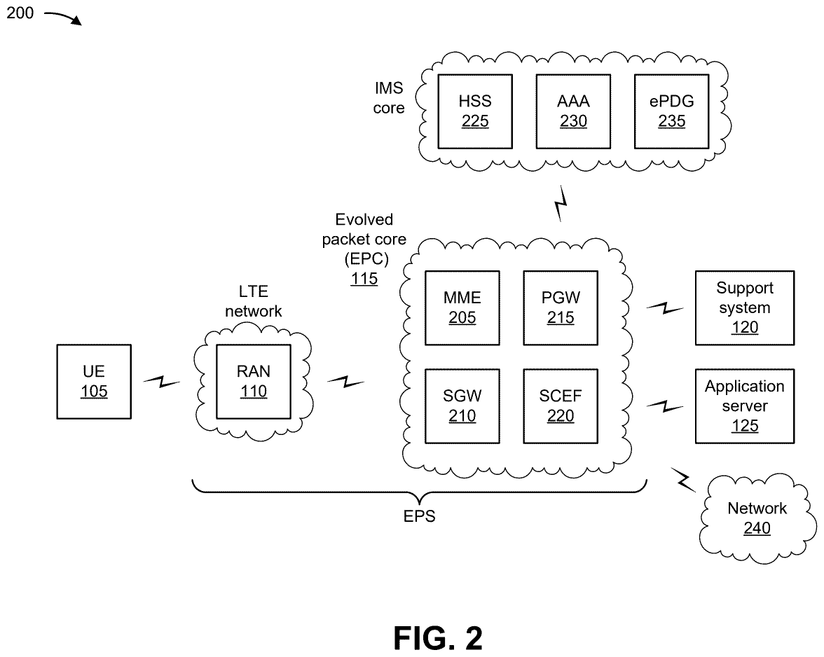

FIG. 2 is a diagram of an example environment 200 in which systems and/or methods, described herein, may be implemented. As shown in FIG. 2, the environment 200 may include the UE or cIoT device) 105, the RAN 110, the support system 120, the application server 125, an MME 205, a serving gateway (SGW) 210, a packet data network gateway (PGW) 215, a service capability exposure function (SCEF) 220, an HSS 225, an authentication, authorization, and accounting (AAA) 230, an evolved packet data gateway (ePDG) 235, and a network 240. Devices of the environment 200 may interconnect via wired connections, wireless connections, or a combination of wired and wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device. In some implementations, the UE 105 may include a cIoT device that connects to the Internet using a cellular network. Examples of a cIoT device may include a smart meter, an asset tracker, a wearable health monitor, a connected car, an industrial sensor, and various types of smart city infrastructure.

The RAN 110 may support, for example, a cellular RAT. The RAN 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The RAN 110 may transfer traffic between the UE 105 (e.g., using a cellular RAT), one or more base stations (e.g., using a wireless interface or a backhaul interface, such as a wired backhaul interface), and/or the core network 115. The RAN 110 may provide one or more cells that cover geographic areas.

In some implementations, the RAN 110 may perform scheduling and/or resource management for the UE 105 covered by the RAN 110 (e.g., the UE 105 covered by a cell provided by the RAN 110). In some implementations, the RAN 110 may be controlled or coordinated by a network controller, which may perform load balancing, network-level configuration, and/or other operations. The network controller may communicate with the RAN 110 via a wireless or wireline backhaul. In some implementations, the RAN 110 may include a network controller, a self-organizing network (SON) module or component, or a similar module or component. In other words, the RAN 110 may perform network control, scheduling, and/or network management functions (e.g., for uplink, downlink, and/or sidelink communications of the UE 105 covered by the RAN 110).

The support system 120 may include one or more devices capable of receiving, generating, storing, processing, providing, and/or routing information, as described elsewhere herein. The support system 120 may include a communication device and/or a computing device. For example, the support system 120 may include a server, such as an application server, a client server, a web server, a database server, a host server, a proxy server, a virtual server (e.g., executing on computing hardware), or a server in a cloud computing system. In some implementations, the support system 120 may include computing hardware used in a cloud computing environment, such as one or more serverless components (e.g., one or more serverless functions).

The application server 125 may include one or more devices capable of receiving, generating, storing, processing, providing, and/or routing information, as described elsewhere herein. The application server 125 may include a communication device and/or a computing device. For example, the application server 125 may include a server, such as an application server, a client server, a web server, a database server, a host server, a proxy server, a virtual server (e.g., executing on computing hardware), or a server in a cloud computing system. In some implementations, the application server 125 may include computing hardware used in a cloud computing environment, such as one or more serverless components (e.g., one or more serverless functions).

Some implementations are described herein as being performed within a long-term evolution (LTE) network for explanatory purposes. Some implementations may be performed within a network that is not an LTE network, such as a third generation (3G) network or a 5G network.

The environment 200 may include an evolved packet system (EPS) that includes an LTE network and/or an evolved packet core (EPC) (e.g., the core network 115) that operate based on a third-generation partnership project (3GPP) wireless communication standard. The LTE network may include the RAN 110 that includes one or more base stations that take the form of evolved Node Bs (eNBs) via which the UE 105 communicates with the EPC. The EPC may include the MME 205, the SGW 210, the PGW 215, and/or the SCEF 220 to enable the UE 105 to communicate with the network 240 and/or an IP multimedia subsystem (IMS) core. The IMS core may include the HSS 225, the AAA 230, and/or the ePDG 235, and may manage device registration and authentication, session initiation, and/or other operations associated with the UE 105. The HSS 225, the AAA 230, and/or the ePDG 235 may reside in the EPC and/or the IMS core.

The MME 205 includes one or more devices, such as one or more server devices, capable of managing authentication, activation, deactivation, and/or mobility functions associated with the UE 105. In some implementations, the MME 205 may perform operations relating to authentication of the UE 105. Additionally, or alternatively, the MME 205 may facilitate the selection of a particular SGW 210 and/or a particular PGW 215 to provide traffic to and/or from the UE 105. The MME 205 may perform operations associated with handing off the UE 105 from a first RAN 110 to a second RAN 110 when the UE 105 is transitioning from a first cell associated with the first RAN 110 to a second cell associated with the second RAN 110. Additionally, or alternatively, the MME 205 may select another MME (not pictured), to which the UE 105 should be handed off (e.g., when the UE 105 moves out of range of the MME 205).

The SGW 210 includes one or more devices capable of routing packets. For example, the SGW 210 may include one or more data processing and/or traffic transfer devices, such as a gateway, a router, a modem, a switch, a firewall, a network interface card (NIC), a hub, a bridge, a server device, an optical add/drop multiplexer (OADM), or any other type of device that processes and/or transfers traffic. In some implementations, the SGW 210 may aggregate traffic received from one or more RANs 110 associated with the LTE network, and may send the aggregated traffic to the network 240 (e.g., via the PGW 215) and/or other network devices associated with the EPC and/or the IMS core. The SGW 210 may receive traffic from network the 240 and/or other network devices, and may send the received traffic to the UE 105 via the RAN 110. Additionally, or alternatively, the SGW 210 may perform operations associated with handing off the UE 105 to and/or from an LTE network.

The PGW 215 includes one or more devices capable of providing connectivity for the UE 105 to external packet data networks (e.g., other than the depicted EPC and/or LTE network). For example, the PGW 215 may include one or more data processing and/or traffic transfer devices, such as a gateway, a router, a modem, a switch, a firewall, a NIC, a hub, a bridge, a server device, an OADM, or any other type of device that processes and/or transfers traffic. In some implementations, the PGW 215 may aggregate traffic received from one or more SGWs 210, and may send the aggregated traffic to the network 240. Additionally, or alternatively, the PGW 215 may receive traffic from the network 240, and may send the traffic to the UE 105 via the SGW 210 and the RAN 110. The PGW 215 may record data usage information (e.g., byte usage), and may provide the data usage information to the AAA 230.

The SCEF 220 includes one or more devices, such as one or more server devices, capable of securely exposing services and capabilities provided by the EPS. The SCEF 220 may include an interface with external applications. The SCEF 220 may provide a trigger to devices (e.g., the UE 105 and/or the support system 120), may retrieve device monitoring data, reachability information and roaming data, and/or the like.

The HSS 225 includes one or more devices, such as one or more server devices, capable of managing (e.g., receiving, generating, storing, processing, and/or providing) information associated with the UE 105. For example, the HSS 225 may manage subscription information associated with the UE 105, such as information that identifies a subscriber profile of a user associated with the UE 105, information that identifies services and/or applications that are accessible to the UE 105, location information associated with the UE 105, a network identifier (e.g., a network address) that identifies the UE 105, information that identifies a treatment of the UE 105 (e.g., quality of service information, a quantity of minutes allowed per time period, a quantity of data consumption allowed per time period, etc.), and/or similar information. The HSS 225 may provide this information to one or more other devices of the environment 200 to support the operations performed by those devices.

The AAA 230 includes one or more devices, such as one or more server devices, that perform authentication, authorization, and/or accounting operations for communication sessions associated with the UE 105. For example, the AAA 230 may perform authentication operations for the UE 105 and/or a user of the UE 105 (e.g., using one or more credentials), may control access, by the UE 105, to a service and/or an application (e.g., based on one or more restrictions, such as time-of-day restrictions, location restrictions, single or multiple access restrictions, read/write restrictions, etc.), may track resources consumed by the UE 105 (e.g., a quantity of voice minutes consumed, a quantity of data consumed, etc.), and/or may perform similar operations.

The ePDG 235 includes one or more devices that provides the UE 105 with access to domain services. For example, the ePDG 235 may include one or more data processing and/or traffic transfer devices, such as a gateway, a router, a modem, a switch, a firewall, a NIC, a hub, a bridge, a server device, an OADM, or any other type of device that processes and/or transfers traffic. The ePDG 235 may perform functions, such as IP address management, support for mobile IP, quality of service (QoS) enforcement, lawful intercept and security, and/or the like.

The network 240 includes one or more wired and/or wireless networks. For example, the network 240 may include a cellular network (e.g., a 5G network, an LTE network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

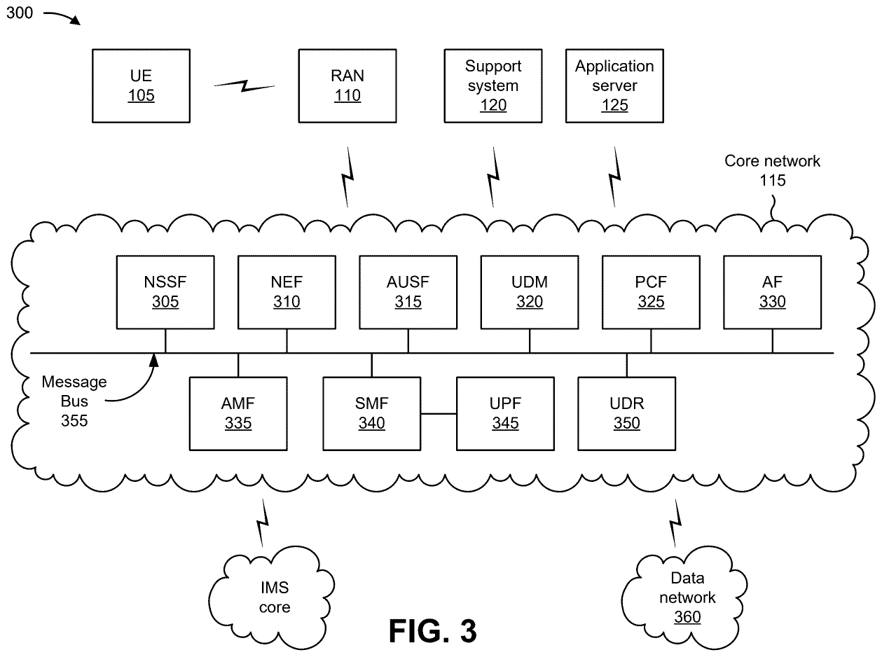

FIG. 3 is a diagram of an example environment 300 in which systems and/or methods described herein may be implemented. As shown in FIG. 3, the example environment 300 may include the UE 105, the RAN 110, the core network 115, the support system 120, the application server 125, the IMS core network, and a data network 360. Devices and/or networks of the example environment 300 may interconnect via wired connections, wireless connections, or a combination of wired and wireless connections. Details of the UE 105, the RAN 110, the support system 120, the application server 125, and the IMS core network are described above in connection with FIG. 2.

In some implementations, the core network 115 may include an example functional architecture in which systems and/or methods described herein may be implemented. For example, the core network 115 may include an example architecture of a 5G next generation (NG) core network included in a 5G wireless telecommunications system. While the example architecture of the core network 115 shown in FIG. 3 may be an example of a service-based architecture, in some implementations, the core network 115 may be implemented as a reference-point architecture and/or a 4G core network, among other examples.

As shown in FIG. 3, the core network 115 may include a number of functional elements. The functional elements may include, for example, a network slice selection function (NSSF) 305, an NEF 310, an authentication server function (AUSF) 315, a UDM component 320, a policy control function (PCF) 325, an application function (AF) 330, an access and mobility management function (AMF) 335, a session management function (SMF) 340, a user plane function (UPF) 345, and/or a UDR 350. These functional elements may be communicatively connected via a message bus 355. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 305 includes one or more devices that select network slice instances for the UE 105. By providing network slicing, the NSSF 305 allows an operator to deploy multiple substantially independent end-to-end networks potentially with the same infrastructure. In some implementations, each slice may be customized for different services.

The NEF 310 includes one or more devices that support exposure of capabilities and/or events in the wireless telecommunications system to help other entities in the wireless telecommunications system discover network services.

The AUSF 315 includes one or more devices that act as an authentication server and support the process of authenticating the UE 105 in the wireless telecommunications system.

The UDM component 320 includes one or more devices that store user data and profiles in the wireless telecommunications system. The UDM component 320 may be used for fixed access and/or mobile access in the core network 115.

The PCF 325 includes one or more devices that provide a policy framework that incorporates network slicing, roaming, packet processing, and/or mobility management, among other examples.

The AF 330 includes one or more devices that support application influence on traffic routing, access to the NEF 310, and/or policy control, among other examples.

The AMF 335 includes one or more devices that act as a termination point for non-access stratum (NAS) signaling and/or mobility management, among other examples.

The SMF 340 includes one or more devices that support the establishment, modification, and release of communication sessions in the wireless telecommunications system. For example, the SMF 340 may configure traffic steering policies at the UPF 345 and/or may enforce user equipment IP address allocation and policies, among other examples.

The UPF 345 includes one or more devices that serve as an anchor point for intraRAT and/or interRAT mobility. The UPF 345 may apply rules to packets, such as rules pertaining to packet routing, traffic reporting, and/or handling user plane QoS, among other examples.

The UDR 350 includes one or more devices that store data grouped into distinct collections of subscription-related data, such as subscription data, policy data, structured data for exposure, application data, and/or the like. The UDR 350 may make the subscription data available, via the UDM component 320, to a number of network functions (e.g., the AUSF 315, the AMF 335, the SMF 340, and/or the like) that control the UE 105's activities within the network. The UDR 350 may make the policy data to the PCF 325. The application data may be stored in the UDR 350 by the external application function, via the NEF 310, in order to be made available to network functions that require, and are authorized to request, subscription-related data.

The message bus 355 represents a communication structure for communication among the functional elements. In other words, the message bus 355 may permit communication between two or more functional elements.

The data network 360 includes one or more wired and/or wireless data networks. For example, the data network 360 may include an IMS, a PLMN, a LAN, a WAN, a MAN, a private network such as a corporate intranet, an ad hoc network, the Internet, a fiber optic-based network, a cloud computing network, a third-party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the example environment 300 may perform one or more functions described as being performed by another set of devices of the example environment 300.

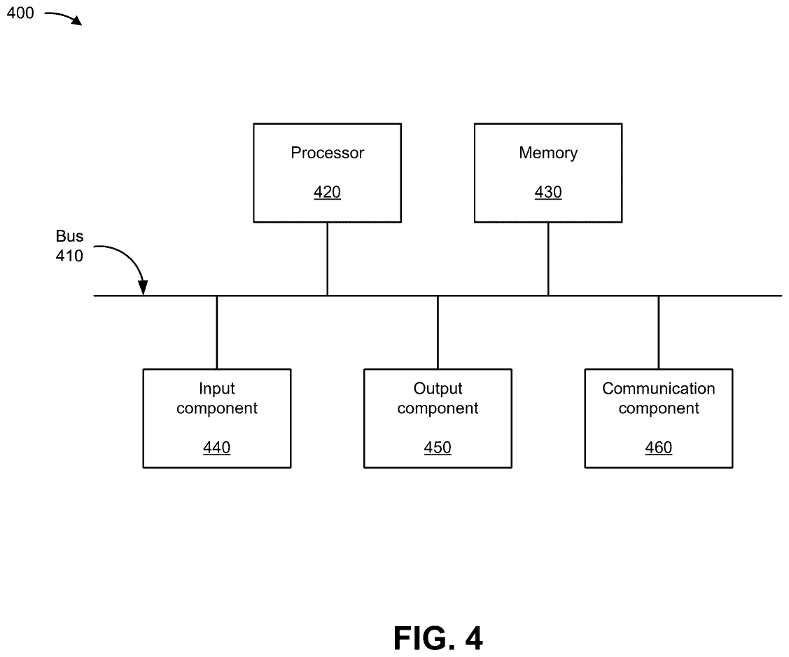

FIG. 4 is a diagram of example components of a device 400, which may correspond to the UE 105, the RAN 110, the support system 120, the application server 125, the MME 205, the SGW 210, the PGW 215, the SCEF 220, the HSS 225, the AAA 230, the ePDG 235, the NSSF 305, the NEF 310, the AUSF 315, the UDM component 320, the PCF 325, the AF 330, the AMF 335, the SMF 340, the UPF 345, and/or the UDR 350. In some implementations, the UE 105, the RAN 110, the support system 120, the application server 125, the MME 205, the SGW 210, the PGW 215, the SCEF 220, the HSS 225, the AAA 230, the ePDG 235, the NSSF 305, the NEF 310, the AUSF 315, the UDM component 320, the PCF 325, the AF 330, the AMF 335, the SMF 340, the UPF 345, and/or the UDR 350 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

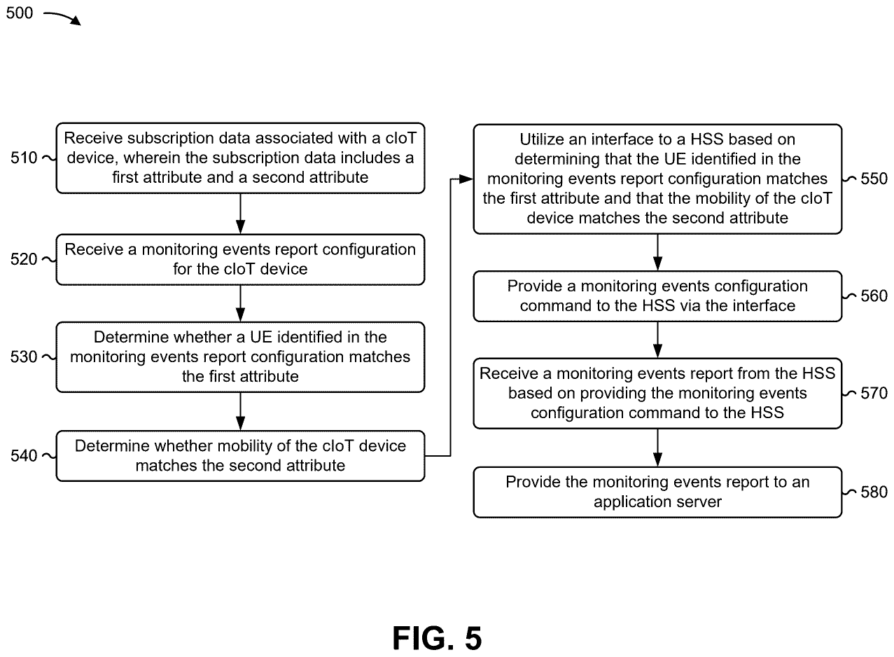

FIG. 5 is a flowchart of an example process 500 for monitoring traffic routing of cIoT devices in a network. In some implementations, one or more process blocks of FIG. 5 may be performed by a device (e.g., the NEF 310). In some implementations, one or more process blocks of FIG. 5 may be performed by another device or a group of devices separate from or including the device, such as a support system (e.g., the support system 120), an application server (e.g., the application server 125), an MME (e.g., the MME 205), an HSS (e.g., the HSS 225), a UDR (e.g., the UDR 350), and/or the like. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving subscription data associated with a cIoT device (block 510). For example, the device may receive subscription data associated with a cIoT device, as described above. In some implementations, the subscription data includes a first attribute and a second attribute. In some implementations, receiving the subscription data includes receiving the subscription data associated with the cIoT device from a UDR. In some implementations, the device is an NEF. In some implementations, the first attribute indicates a cIoT RAT type and the second attribute indicates operation under a 5G NSA configuration. In some implementations, the cIoT device is configured to operate under a NB-IoT configuration or a Cat-M1 configuration.

As further shown in FIG. 5, process 500 may include receiving a monitoring events report configuration for the cIoT device (block 520). For example, the device may receive a monitoring events report configuration for the cIoT device, as described above. In some implementations, the monitoring events report configuration specifies one or more parameters for monitoring the cIoT device.

As further shown in FIG. 5, process 500 may include determining whether a UE identified in the monitoring events report configuration matches the first attribute (block 530). For example, the device may determine whether a UE identified in the monitoring events report configuration matches the first attribute, as described above.

As further shown in FIG. 5, process 500 may include determining whether mobility of the cIoT device matches the second attribute (block 540). For example, the device may determine whether mobility of the cIoT device matches the second attribute, as described above.

As further shown in FIG. 5, process 500 may include utilizing an interface to an HSS of the network based on determining that the UE identified in the monitoring events report configuration matches the first attribute and that the mobility of the cIoT device matches the second attribute (block 550). For example, the device may utilize an interface to an HSS of the network based on determining that the UE identified in the monitoring events report configuration matches the first attribute and that the mobility of the cIoT device matches the second attribute, as described above. In some implementations, utilizing the interface to the HSS of the network includes utilizing the interface to the HSS and not a service-based interface (SBI) of a UDM component of the network.

As further shown in FIG. 5, process 500 may include providing a monitoring events configuration command to the HSS via the interface (block 560). For example, the device may provide a monitoring events configuration command to the HSS via the interface, as described above. In some implementations, providing the monitoring events configuration command to the HSS via the interface includes providing the monitoring events configuration command to the HSS without routing the monitoring events configuration command through a UDM component of the network.

As further shown in FIG. 5, process 500 may include receiving a monitoring events report from the HSS based on providing the monitoring events configuration command to the HSS (block 570). For example, the device may receive a monitoring events report from the HSS based on providing the monitoring events configuration command to the HSS, as described above. In some implementations, the monitoring events configuration command causes the HSS to provide a monitoring events context create command to an MME of the network and to receive the monitoring events report from the MME. In some implementations, the monitoring event report includes information associated with one or more events detected by the cIoT device.

As further shown in FIG. 5, process 500 may include providing the monitoring events report to an application server (block 580). For example, the device may provide the monitoring events report to an application server, as described above.

In some implementations, process 500 includes storing the subscription data with the first attribute and the second attribute in a data structure accessible by the device. In some implementations, process 500 includes receiving an update to one of the first attribute or the second attribute, and updating the subscription data based on the update to the one of the first attribute or the second attribute. In some implementations, process 500 includes receiving a monitoring events subscription command from the application server, and enabling or disabling forwarding of the monitoring events subscription command to the HSS based on the second attribute.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device of a network, subscription data associated with a cellular Internet of Things (cIoT) device,
wherein the subscription data includes a first attribute and a second attribute;
receiving, by the device, a monitoring events report configuration for the cIoT device;
determining, by the device, whether a user equipment (UE) identified in the monitoring events report configuration matches the first attribute;
determining, by the device, whether mobility of the cIoT device matches the second attribute;
utilizing, by the device, an interface to a home subscriber server of the network based on determining that the UE identified in the monitoring events report configuration matches the first attribute and that the mobility of the cIoT device matches the second attribute;
providing, by the device, a monitoring events configuration command to the home subscriber server via the interface;
receiving, by the device, a monitoring events report from the home subscriber server based on providing the monitoring events configuration command to the home subscriber server; and
providing, by the device, the monitoring events report to an application server.

2. The method of claim 1, wherein receiving the subscription data comprises:
receiving the subscription data associated with the cIoT device from a unified data repository.

3. The method of claim 1, wherein the device is a network exposure function.

4. The method of claim 1, wherein the first attribute indicates a cIoT radio access technology type and the second attribute indicates operation under a fifth-generation non-standalone configuration.

5. The method of claim 1, wherein utilizing the interface to the home subscriber server of the network comprises:
utilizing the interface to the home subscriber server and not a service-based interface of a unified data management component of the network.

6. The method of claim 1, wherein the monitoring events configuration command causes the home subscriber server to provide a monitoring events context create command to a mobility management entity of the network and to receive the monitoring events report from the mobility management entity.

7. The method of claim 1, further comprising:
storing the subscription data with the first attribute and the second attribute in a data structure accessible by the device.

8. A device, comprising:
one or more processors configured to:
receive subscription data associated with a cellular Internet of Things (cIoT) device,
wherein the subscription data includes a first attribute and a second attribute,
wherein the first attribute indicates a cIoT radio access technology type and the second attribute indicates operation under a fifth-generation non-standalone configuration;
receive a monitoring events report configuration for the cIoT device;
determine whether a user equipment (UE) identified in the monitoring events report configuration matches the first attribute;
determine whether mobility of the cIoT device matches the second attribute;
utilize an interface to a home subscriber server based on determining that the UE identified in the monitoring events report configuration matches the first attribute and that the mobility of the cIoT device matches the second attribute;
provide a monitoring events configuration command to the home subscriber server via the interface;
receive a monitoring events report from the home subscriber server based on providing the monitoring events configuration command to the home subscriber server; and
provide the monitoring events report to an application server.

9. The device of claim 8, wherein the monitoring events report configuration specifies one or more parameters for monitoring the cIoT device.

10. The device of claim 8, wherein the monitoring event report includes information associated with one or more events detected by the cIoT device.

11. The device of claim 8, wherein the one or more processors are further configured to:
receive an update to one of the first attribute or the second attribute; and
update the subscription data based on the update to the one of the first attribute or the second attribute.

12. The device of claim 8, wherein the one or more processors, to provide the monitoring events configuration command to the home subscriber server via the interface, are configured to:
provide the monitoring events configuration command to the home subscriber server without routing the monitoring events configuration command through a unified data management component.

13. The device of claim 8, wherein the cIoT device is configured to operate under a narrowband Internet of Things configuration or a category M1 configuration.

14. The device of claim 8, wherein the one or more processors are further configured to:
receive a monitoring events subscription command from the application server; and
enable or disabling forwarding of the monitoring events subscription command to the home subscriber server based on the second attribute.

15. A non-transitory computer-readable medium storing a set of instructions, the set of instructions comprising:
one or more instructions that, when executed by one or more processors of a device, cause the device to:
receive, from a unified data repository, subscription data associated with a cellular Internet of Things (cIoT) device,
wherein the subscription data includes a first attribute and a second attribute;
receive a monitoring events report configuration for the cIoT device;
determine whether a user equipment (UE) identified in the monitoring events report configuration matches the first attribute;
determine whether mobility of the cIoT device matches the second attribute;
utilize an interface to a home subscriber server based on determining that the UE identified in the monitoring events report configuration matches the first attribute and that the mobility of the cIoT device matches the second attribute;
provide a monitoring events configuration command to the home subscriber server via the interface;
receive a monitoring events report from the home subscriber server based on providing the monitoring events configuration command to the home subscriber server; and
provide the monitoring events report to an application server.

16. The non-transitory computer-readable medium of claim 15, wherein the first attribute indicates a cIoT radio access technology type and the second attribute indicates operation under a fifth-generation non-standalone configuration.

17. The non-transitory computer-readable medium of claim 15, wherein the one or more instructions further cause the device to:
store the subscription data with the first attribute and the second attribute in a data structure accessible by the device.

18. The non-transitory computer-readable medium of claim 15, wherein the monitoring events report configuration specifies one or more parameters for monitoring the cIoT device.

19. The non-transitory computer-readable medium of claim 15, wherein the monitoring event report includes information associated with one or more events detected by the cIoT device.

20. The non-transitory computer-readable medium of claim 15, wherein the one or more instructions further cause the device to:
receive an update to one of the first attribute or the second attribute; and
update the subscription data based on the update to the one of the first attribute or the second attribute.
